(19) United States
(12) Patent Application Publication
(10) Pub. No.: US 2021/0400134 A1
(43) Pub. Date: Dec. 23, 2021

(54) PORTABLE TERMINAL DEVICE, COMMUNICATION CONTROL SYSTEM, AND COMMUNICATION CONTROL METHOD

(71) Applicant: Mitsubishi Electric Corporation, Tokyo (JP)

(72) Inventors: Mari OCHIAI, Tokyo (JP); Teruko FUJII, Tokyo (JP)

(73) Assignee: Mitsubishi Electric Corporation, Tokyo (JP)

(21) Appl. No.: 17/465,355

(22) Filed: Sep. 2, 2021

Related U.S. Application Data
(63) Continuation of application No. PCT/JP2019/012487, filed on Mar. 25, 2019.

(51) Int. Cl. H04M 1/72463; H04W 48/04; H04W 4/021

(52) U.S. Cl. CPC H04M 1/72463; H04W 4/022; H04W 48/04

(57) ABSTRACT

A conventional portable terminal device identifies a specific place where the use of a mobile phone is prohibited only from electromagnetic waves generated from equipment with a motor and a vehicle, etc., or equipment with a digital circuit and a treatment apparatus, etc., and the radio wave emission is uniformly stopped in the specific place. Therefore, since an operating environment is not taken into consideration, a problem arises in that communication cannot be restricted in accordance with a purpose. A portable terminal device is provided with: a direct wireless communication unit to perform direct communication permitted for a specific purpose; a determination unit to determine whether or not an operating environment of the device is an operating environment to permit the direct communication; and a control unit to control the direct communication by the direct wireless communication unit on the basis of a determination result of the determination unit.

### CROSS REFERENCE TO RELATED APPLICATIONS

This application is a Continuation of PCT International Application No. PCT/JP2019/012487, filed on Mar. 25, 2019, which is hereby expressly incorporated by reference into the present application.

### TECHNICAL FIELD

The present disclosure relates to a portable terminal device, a communication control system, a communication control method, and a communication control program that perform communication control of direct communication.

### BACKGROUND ART

In the field of communication based on Long Term Evolution (LTE) and a fifth-generation mobile communication system (5G), communication via a base station and communication without passing through a base station are included. Communication without passing through the base station is called direct communication, and the communication can be performed only between direct communication devices that are devices to perform the direct communication without passing through the base station. The direct communication is expected to be used in, for example, Vehicle to Everything (V2X). The direct communication can be operated in the same frequency band as that for the communication via the base station, but an operation in a frequency band different from that for the communication via the base station is also assumed, and in the future, allocation of a frequency may be considered for the purpose of V2X.

Here, V2X will be described. V2 means “Vehicle to” and is one of communication technologies related to vehicles. V2 has various combinations depending on what is targeted. For example, Vehicle to Cellular Network (V2N) is a communication technology between a vehicle and the Internet. Vehicle to Vehicle (V2V) means vehicle-to-vehicle communication. Vehicle to roadside Infrastructure (V2I) means road-to-vehicle communication. Vehicle-to-Pedestrian (V2P) is a communication technology between a vehicle and a pedestrian holding a smartphone. V2X means overall communication technologies between these vehicles and objects.

In recent years, as portable terminal devices such as smartphones and tablet terminals have become widespread and sophisticated, the use of portable terminal devices as a tool related to vehicle driving has increased. For example, a navigation system in a portable terminal device is used in a vehicle. In the future, when the direct communication is to be used in V2X, there is a possibility that a communication function of the direct communication provided in a portable terminal device can be used for the direct communication in V2X. When the direct communication of V2X becomes possible by bringing a portable terminal device into a vehicle, it becomes easy to add a communication function later to the vehicle that is not equipped with a communication function, so that the spread of V2X is accelerated.

However, when a communication function of the direct communication for a specific purpose such as V2X is provided in a portable terminal device, an application that is not for an intended purpose may possibly use the communication function. For example, there is a possibility that the communication function of the direct communication of V2X may be used for information exchange between portable terminal devices for purposes other than those of V2X. Thus, if the communication function of the direct communication for the specific purpose can be used for an application that is not for the intended purpose, the direct communication of V2X for the intended purpose may be affected by interference or the like. In such a case, it is necessary to restrict the portable terminal device not to perform the direct communication for the specific purpose in an application that is not for the intended purpose.

Further, the application to the vehicle is described above, but in 5G, frequency allocation to a private network has also been studied. When a portable terminal device using a dedicated frequency is used within the private network, a communication function of the direct communication for directly exchanging information between portable terminal devices may be utilized. When a portable terminal device having the communication function of the direct communication is brought out of a range of the private network, it is necessary to restrict the portable terminal device from performing the direct communication using the dedicated frequency of the private network.

Patent Document 1 discloses a technology for identifying a specific place from periodic electromagnetic waves generated from equipment with a motor and a vehicle, etc., or equipment with a digital circuit, and a treatment apparatus, etc., and for restricting the radio wave emission when the specific place is identified, the specific place being a place in which the use of a mobile phone is prohibited, such as a hospital.

### CITATION LIST

### Patent Document

Patent Document 1: Japanese Patent Application Laid-open No. 2002-186046

### SUMMARY OF INVENTION

### Problems to be Solved by Invention

However, in the above-described conventional portable terminal device, the specific place where the use of the mobile phone is prohibited is identified only by electromagnetic waves generated from equipment with a motor and a vehicle, etc., or equipment with a digital circuit, and a treatment apparatus, etc., and the radio wave emission is uniformly stopped in the specific place. Therefore, since an operating environment is not taken into consideration, a problem arises in that the communication cannot be restricted in accordance with a purpose.

The present application has been made in order to solve the above-described problem, and an object thereof is to provide a portable terminal device, a communication control system, a communication control method, and a communication control program that control the direct communication in consideration of the operating environment of the portable terminal device in the portable terminal device that performs the direct communication permitted for the specific purpose.

### Means for Solving Problems

A portable terminal device according to the present disclosure includes: a direct wireless communication unit to perform direct communication permitted for a specific purpose; a determination unit to determine whether or not an operating environment of the device is an operating environment to permit the direct communication; and a control unit to control the direct communication by the direct wireless communication unit on the basis of a determination result of the determination unit.

A communication control system comprises: a portable terminal device capable of direct communication; and a server to determine whether the portable terminal device is permitted to perform the direct communication on the basis of information received from the portable terminal device and a vehicle, wherein the portable terminal device includes: a direct wireless communication unit to perform the direct communication permitted for a specific purpose; a base station wireless communication unit to transmit to the server, portable terminal device sensor information being information on the portable terminal device acquired from a sensor of the portable terminal device and to receive a determination result from the server whether or not the direct communication is permitted; and a control unit to control the direct communication by the direct wireless communication unit on the basis of the determination result, and the server includes: a wireless communication unit to receive from the vehicle, vehicle sensor information being sensor information on the vehicle, to receive the portable terminal device sensor information from the portable terminal device, and to transmit a determination result to the portable terminal device whether or not the direct communication is permitted; and a determination unit to determine whether or not an operating environment of the portable terminal device is an operating environment to permit the direct communication on the basis of the vehicle sensor information and the portable terminal device sensor information.

### Effect of Invention

According to the present disclosure, it is possible to control the direct communication in consideration of the operating environment of the portable terminal device.

### BRIEF DESCRIPTION OF DRAWINGS

FIG. 1 is a functional block diagram of a portable terminal device according to Embodiment 1 of the present disclosure.

FIG. 2 is a hardware configuration diagram of the portable terminal device according to Embodiment 1 of the present disclosure.

FIG. 3 is a flowchart showing operation of a determination unit according to Embodiment 1 of the present disclosure.

FIG. 4 is a functional block diagram of a portable terminal device according to Embodiment 2 of the present disclosure.

FIG. 5 is a hardware configuration diagram of the portable terminal device according to Embodiment 2 of the present disclosure.

FIG. 6 is a functional block diagram of a portable terminal device according to Embodiment 3 of the present disclosure.

FIG. 7 is a flowchart showing operation of a determination unit according to Embodiment 3 of the present disclosure.

### MODES FOR CARRYING OUT INVENTION

### Embodiment 1

In Embodiment 1, as an example, a case will be described below in which a communication function of direct communication provided in a smartphone being a portable terminal device is used for the direct communication of V2X.

The direct communication is mainly used in vehicle-to-vehicle communication and road-to-vehicle communication as purposes of V2X. The vehicle-to-vehicle communication, road-to-vehicle communication, and communication during a travelling of a vehicle (including stopping) are V2X, and are targets of the direct communication.

When V2X is performed, generally, a dedicated in-vehicle device that performs the direct communication is installed in the vehicle, and the communication is performed in the vehicle. In contrast, as in Embodiment 1, there is a case where the portable terminal device provided with a direct communication function is brought into a vehicle to perform V2X. In such a case, it is possible to bring the portable terminal device out of the vehicle. Since a portable terminal device is typically brought into a vehicle and performs communication in the vehicle, when the portable terminal device is outside the vehicle, it is determined that the communication is not of V2X, and the portable terminal device needs to restrict the direct communication.

Further, in the road-to-vehicle communication, although there is an application that operates regardless of vehicle movement, such as the service of ETC2.0, it is sufficient that the communication can be performed when the portable terminal device is in the vehicle and the vehicle is in operation, as in the current ETC2.0.

In Embodiment 1 of the present disclosure, the portable terminal device is provided with a function of determining whether or not the device is in the vehicle, and when it is determined that the device is not in the vehicle, the portable terminal device restricts the direct communication. In contrast, when the portable terminal device determines that the portable terminal device is in the vehicle on the basis of information acquired from the vehicle by a certain application, there is a high possibility that an application related to the vehicle is being executed during driving or the like in other applications. Since this case is of V2X, the portable terminal device permits the direct communication in communication of other applications that can operate independently of the vehicle. The portable terminal device restricts the direct communication of V2X to the communication only in the vehicle, and thus it is possible to suppress communication using the direct communication other than V2X. In the way described above, the portable terminal device can restrict the direct communication that is not for the intended purpose and suppress interference. Further, by enabling the direct communication of V2X using a communication terminal device other than a communication device installed in a vehicle, it is possible to use communication in a retrofitting manner, and it is possible to contribute to the spread of V2X.

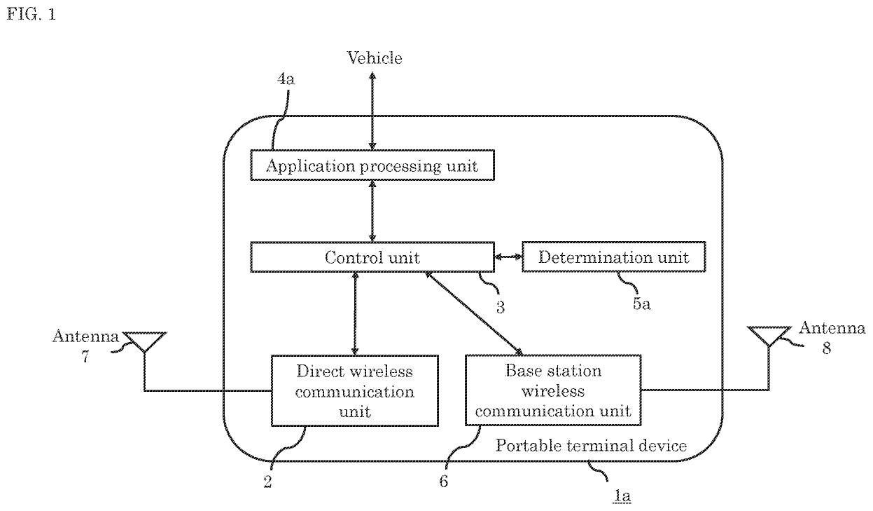

FIG. 1 is a functional block diagram of a portable terminal device 1a according to Embodiment 1 of the present disclosure.

In FIG. 1, the portable terminal device 1a includes a direct wireless communication unit 2 to perform the direct communication, a control unit 3 to control the communication, an application processing unit 4a to execute an application, a determination unit 5a to determine whether the device is in a vehicle, a base station wireless communication unit 6 to perform communication via a base station, an antenna 7 connected to the direct wireless communication unit 2, and an antenna 8 connected to the base station wireless communication unit 6. Although the portable terminal device 1a may include other functional components, those not directly related to the contents of the present disclosure will be omitted.

The direct wireless communication unit 2 performs the direct communication by using a frequency band permitted for a specific purpose via the antenna 7. To be more specific, the frequency band permitted for the specific purpose is a frequency band allocated for the direct communication of V2X, and the direct wireless communication unit 2 performs the direct communication with another direct communication device in the frequency band allocated for the direct communication of V2X. Note that, although the frequency band permitted for the specific purpose is the frequency band allocated for the direct communication of V2X, the frequency band may be the same as the frequency band allocated for V2X in the communication via the base station.

The direct wireless communication unit 2 is connected to the control unit 3 and the antenna 7.

The antenna 7 transmits and receives radio waves through the direct communication. The antenna 7 is connected to the direct wireless communication unit 2.

The base station wireless communication unit 6 performs communication via the base station through the antenna 8. The base station wireless communication unit 6 is a communication means for communication that is not performed with the direct communication, and is, for example, the cellular communication. The base station wireless communication unit 6 is connected to the control unit 3 and the antenna 8.

The antenna 8 transmits and receives radio waves via the base station. The antenna 8 is connected to the base station wireless communication unit 6.

The control unit 3 controls communication of the direct wireless communication unit 2 and the base station wireless communication unit 6. In particular, the control unit 3 controls the direct communication of the direct wireless communication unit 2 on the basis of a determination result of the determination unit 5a.

For example, when the determination unit 5a determines that an operating environment of the device is not in the vehicle, the control unit 3 restricts the direct communication performed by the direct wireless communication unit 2.

The control unit 3 is connected to the direct wireless communication unit 2, the application processing unit 4a, the determination unit 5a, and the base station wireless communication unit 6.

The application processing unit 4a executes applications including an application that uses the direct communication. Applications include an application that can operate by communicating with the vehicle to exchange information and other applications that can operate independently of the vehicle. Examples of the applications that can operate by communicating with the vehicle to exchange information include an application that uses speed information and position information of the vehicle, an application that uses speed information and position information of another vehicle, a pedestrian, or the like, and an application that provides probe information to the vehicle-to-vehicle communication and a roadside unit. The other applications that can operate independently of the vehicle are, for example, an application that uses information related to a store and a parking lot along a road, an application that uses information related to a route and a map of the vehicle, and information related to navigation. Specific examples of such applications include an application for the current ETC2.0 service and an application for a navigation system.

The application processing unit 4a acquires from the vehicle, vehicle information being information related to the vehicle or control information for the communication between the portable terminal device 1a and the vehicle and uses them in the applications. The application processing unit 4a transmits the vehicle information or the control information acquired from the vehicle to the determination unit 5a via the control unit 3.

The application processing unit 4a executes one or more applications and communicates with another direct communication device by the direct communication via the control unit 3, the direct wireless communication unit 2, and the antenna 7. Specifically, when transmitting information from the application processing unit 4a to the another direct communication device by the direct communication, the application processing unit 4a transmits information to the connected control unit 3, and the information to be transmitted that is controlled by the control unit 3 is transmitted to the another direct communication device through the direct wireless communication unit 2 and the antenna 7 by the direct communication. When the application processing unit 4a receives information from the another direct communication device, the information received via the antenna 7 and the direct wireless communication unit 2 is passed to the control unit 3, the received information is passed from the control unit 3 to the application processing unit 4a, and the application processing unit 4a uses the received information in an application. When performing the communication via the base station, the application processing unit 4a performs the communication by the base station wireless communication unit 6 and the antenna 8 instead of the direct wireless communication unit 2 and the antenna 7. Note that, a plurality of applications may be executed by the application processing unit 4a.

The application processing unit 4a is connected to the control unit 3 and the vehicle.

The determination unit 5a determines whether or not the operating environment of the portable terminal device 1a is an operating environment in which the direct communication is permitted, on the basis of the vehicle information or the control information acquired from the vehicle by the application processing unit 4a.

Here, the vehicle information is, for example, speed information or position information of the vehicle acquired from the vehicle. The control information is, for example, timing information for transmitting and receiving information between the portable terminal device 1a and the vehicle. The vehicle information and the control information are examples of first acquisition information that is information acquired from the vehicle in which the portable terminal device 1a exists.

The first acquisition information is an example of information related to the specific purpose. An environment in which the portable terminal device 1a is in the vehicle is an example of the operating environment that permits the direct communication.

Specifically, through an application that can operate by communicating to exchange information with the vehicle, the determination unit 5a determines that the portable terminal device 1a is in the vehicle when the vehicle information or the control information is acquired from the vehicle in which the portable terminal device 1a exists. When determining that the portable terminal device 1a is in the vehicle, the determination unit 5a permits the control unit 3 to transmit, by the direct communication, information to be transmitted to the another direct communication device such as another portable terminal device, an in-vehicle device, or the roadside unit from an application of the application processing unit 4a that can operate independently of the vehicle. When determining that the portable terminal device 1a is not in the vehicle, the determination unit 5a does not permit the control unit 3 to transmit, by the direct communication, information to be transmitted to the another direct communication device from the application of the application processing unit 4a that can operate independently of the vehicle.

The determination unit 5a is connected to the control unit 3.

Next, a hardware configuration of the portable terminal device 1a according to Embodiment 1 will be described.

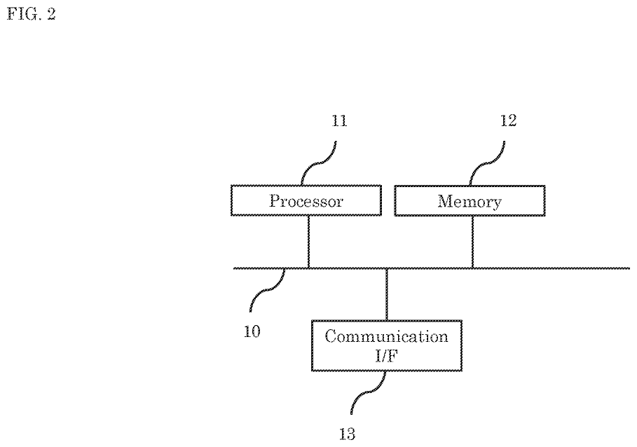

FIG. 2 is the hardware configuration diagram of the portable terminal device 1a according to Embodiment 1 of the present disclosure. The configuration of the portable terminal device 1a according to Embodiment 1 of the present disclosure will be described referring to FIG. 2.

The portable terminal device 1a includes a bus 10, a processor 11, a memory 12, and a communication I/F 13. The individual function of the portable terminal device 1a is implemented by software, firmware, or a combination of the software and the firmware. The software, the firmware, or a combination of the software and the firmware may be described as a program.

The bus 10 is a signal path that electrically connects the devices to exchange data.

The processor 11 is a central processing unit (CPU) that executes a program stored in the memory 12. The processor 11 connects the other devices via the bus 10 and controls these units. The processor 11 reads the program in the memory 12 and executes the program. The processor 11 loads at least a part of an operating system (OS) stored in the memory 12 and executes the program while executing the OS. The processor 11 may be an integrated circuit (IC) that performs processing, and thus may be a microprocessor, a microcomputer, or a digital signal processor (DSP). The control unit 3, the application processing unit 4a, and the determination unit 5a are implemented by the processor 11 that reads and executes the program loaded in the memory 12.

The memory 12 stores software, firmware or a program in which a combination of the software and the firmware is described. Further, the memory 12 stores the vehicle information, the control information, and the like. The memory 12 is, for example, a nonvolatile or volatile semiconductor memory such as a random access memory (RAM), a read only memory (ROM), a flash memory, an erasable programmable read only memory (EPROM), an electrically erasable programmable read only memory (EEPROM), or a hard disk drive (HDD), or a portable recording medium such as a magnetic disk, a flexible disk, an optical disk, a compact disk, a mini disk, or a digital versatile disc (DVD). The memory 12 also stores the OS. The control unit 3, the application processing unit 4a, and the determination unit 5a are implemented by a program stored in the memory 12. In the memory 12, each of the functions of the control unit 3, the application processing unit 4a, and the determination unit 5a may be implemented by a separate memory.

The communication I/F 13 is a device to be connected to a network for the communication. The communication I/F collectively implements functions of the direct wireless communication unit 2, the base station wireless communication unit 6, the antenna 7, and the antenna 8 when transmitting and receiving information from the vehicle to the application processing unit 4a.

The information etc. of each unit is stored in the memory 12 or a register or a cache memory in the CPU that is the processor 11.

The memory 12 may be a storage medium. The memory 12 may be a combination of a memory and the storage medium.

Although not illustrated, as another example, the portable terminal device 1a may be configured with a bus, a communication I/F, and a processing circuit. The bus and the communication I/F are the same as those in FIG. 2. The processing circuit is, for example, a single circuit, a composite circuit, a programmed processor, a parallel programmed processor, an application specific integrated circuit (ASIC), a field-programmable gate array (FPGA), or a combination thereof. The processing circuit collectively implements the functions of the control unit 3, the application processing unit 4a, and the determination unit 5a. In the processing circuit, the functions of the control unit 3, the application processing unit 4a, and the determination unit 5a may be implemented by separate processing circuits.

Furthermore, some of the functions of the control unit 3, the application processing unit 4a, and the determination unit 5a may be implemented by dedicated hardware, and some of the functions may be implemented by software or firmware. For example, the functions of the control unit 3 and the determination unit 5a may be implemented by a processing circuit serving as dedicated hardware, and the functions of the application processing unit 4a may be implemented by a CPU serving as a processing circuit reading and executing a program stored in the memory. The processing circuit can implement each function of the portable terminal device 1a by hardware, software, firmware, or a combination thereof.

Units and devices in the portable terminal device 1a are connected to one another via communication. The communication to be used may be wired communication or wireless communication.

Next, operation of the portable terminal device 1a will be described.

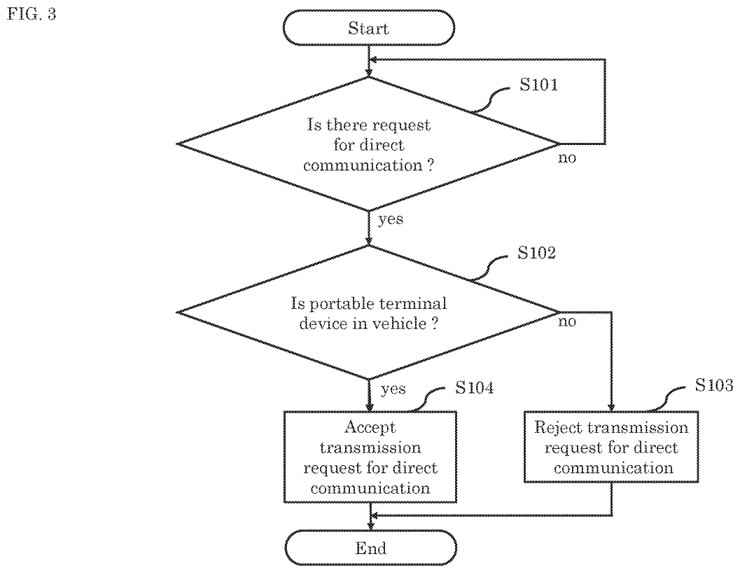

FIG. 3 is a flowchart illustrating operation of the determination unit 5a according to Embodiment 1 of the present disclosure. The operation of the determination unit 5a will be described below referring to FIG. 3.

In Step S101, the determination unit 5a determines whether or not there is a transmission request from an application activated by the application processing unit 4a to the control unit 3. When the determination unit 5a determines that there is the transmission request, the result is Yes in Step S101 and the processing proceeds to Step S102. When the determination unit 5a determines that there is no transmission request, the result is No in Step S101 and Step S101 is repeated.

In Step S102, the determination unit 5a determines whether or not the portable terminal device 1a is in a vehicle. Specifically, the determination unit 5a determines whether or not the application processing unit 4a acquires the vehicle information or the control information from the vehicle. For example, in a case where the application processing unit 4a executes an application that uses speed information and position information of the vehicle and the application acquires the speed information and position information of the vehicle from the vehicle, the determination unit 5a determines that the portable terminal device 1a is in the vehicle with the fact that the vehicle information or the control information is acquired, the result is Yes in Step S102, and the processing proceeds to Step S104. In a case where the vehicle information or the control information cannot be acquired, the determination unit 5a determines that the portable terminal device 1a is not in the vehicle, the result in Step S102 is No, and the processing proceeds to Step S103.

In Step S103, the determination unit 5a notifies the control unit 3 that the transmission request is rejected, and the processing ends. Note that, at this time, the control unit 3 restricts the transmission of the information from the application by the direct communication of V2X of the direct wireless communication unit 2 on the basis of the determination result of the determination unit 5a.

In Step S104, the determination unit 5a notifies the control unit 3 that the transmission request is permitted, and the processing ends. Note that, at this time, the control unit 3 controls to transmit information from the application by the direct communication of V2X of the direct wireless communication unit 2 on the basis of the determination result of the determination unit 5a.

After the execution of Step S103 or Step S104, the processing returns to Step S101, and the processing described above is repeated until the power supply is turned off or until there is a trigger for termination of the processing, for example, a termination operation is performed, and thereby the direct communication for a purpose different from the intended purpose can be restricted. Although the processing described above is assumed to be repeated, the processing may be performed only once without being repeated.

In the portable terminal device 1a of Embodiment 1, the determination unit 5a determines whether or not the portable terminal device 1a is in the vehicle on the basis of whether or not the vehicle information or the control information is acquired, and when it is determined that the device is not in the vehicle, the control unit 3 restricts the direct communication. Therefore, it is possible to control the direct communication in consideration of the operating environment of the portable terminal device 1a.

Further, in Embodiment 1, the portable terminal device 1a can suppress interference by restricting direct communication for a purpose different from the intended purpose.

In Embodiment 1, the portable terminal device 1a enables the direct communication of the V2X using the communication terminal device other than the communication device installed in the vehicle, thereby enabling the use of the communication in a retrofitting manner to the vehicle.

In Embodiment 1, an example in which the determination unit 5a is provided outside the control unit 3 is described. However, the determination unit 5a may be an internal function of the control unit 3.

In Embodiment 1, the determination unit 5a determines that the portable terminal device 1a is in the vehicle and permits the direct communication when the portable terminal device 1a acquires the vehicle information or the control information. However, when the determination unit 5a acquires the control information, in addition to this determination of whether or not the control information is acquired, the determination unit may acquire vehicle information and determine that the portable terminal device 1a is in the vehicle and permit the direct communication when determining that the vehicle is in operation (engine or the like is switched on) on the basis of the vehicle information. Here, for example, the vehicle information is authentication information between the vehicle and the portable terminal device 1a, negotiation information, transmission information from the vehicle, or the like. In this way, by adding the determination as to whether or not the vehicle is in operation, the accuracy of the determination as to whether or not the portable terminal device 1a is in the vehicle is improved.

### Embodiment 2

In Embodiment 1, the determination unit 5a determines that the portable terminal device 1a is in the vehicle when the vehicle information or the control information is acquired from the vehicle, and determines that the portable terminal device 1a is not in the vehicle when the vehicle information or the control information is not acquired from the vehicle, and the control unit 3 controls the direct communication of the direct wireless communication unit 2 on the basis of the determination result.

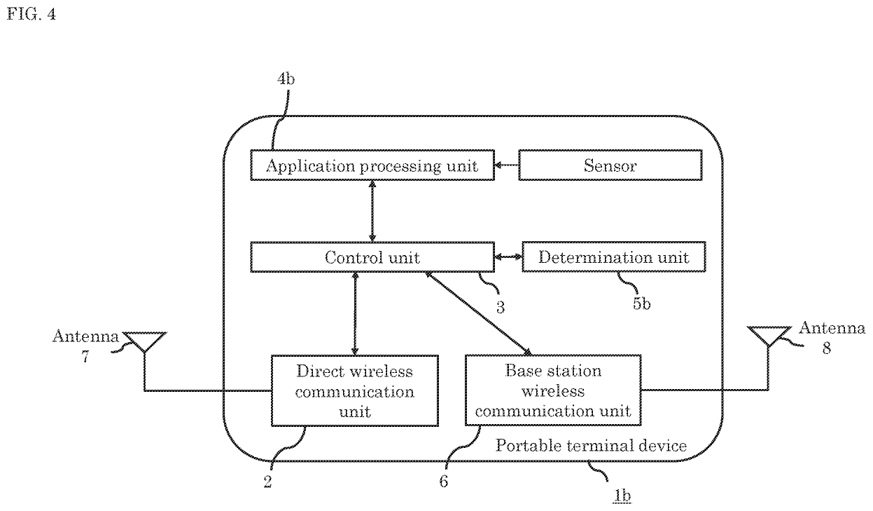

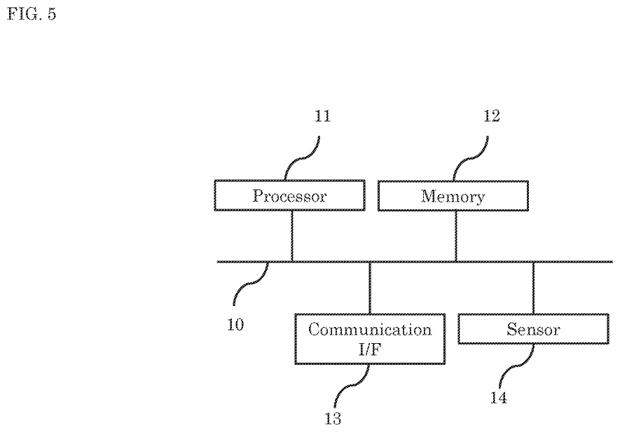

In Embodiment 2, as illustrated in FIGS. 4 to 5, a determination unit 5b determines whether or not a portable terminal device 1b is in a vehicle on the basis of information only in the portable terminal device 1b, instead of determining whether or not the portable terminal device 1b is in the vehicle on the basis of whether or not the vehicle information or the control information is acquired from the vehicle. The rest is the same as that in Embodiment 1. In the following description, the same reference numerals are given to the configurations and the operation already described, and repetitive descriptions will be omitted.

FIG. 4 is a functional block diagram of the portable terminal device 1b according to Embodiment 2 of the present disclosure.

In Embodiment 2, instead of the application processing unit 4a and the determination unit 5a in FIG. 1 in Embodiment 1, an application processing unit 4b and a determination unit 5b are added as components of the functional block diagram. In Embodiment 2, a sensor 9 is newly added as a component of the functional block diagram.

The sensor 9 is a sensor installed on the portable terminal device 1b. The sensor 9 is, for example, an acceleration sensor, a vibration sensor, or a sensor that detects a radio wave in a low frequency (LF) band or an ultra-high frequency (UHF) band for the communication with a smart key of a vehicle. The sensor 9 transmits sensor information to the application processing unit 4b or the determination unit 5b. The sensor 9 is connected to the application processing unit 4b or the determination unit 5b.

The application processing unit 4b acquires the sensor information from the sensor 9 and uses the sensor information for an application. The application processing unit 4b transmits at least one of the sensor information acquired from the sensor 9, calculation information calculated by an application from the sensor information, and information on an execution of an application related to the vehicle, to the determination unit 5b via the control unit 3. The application processing unit 4b is connected to the sensor 9 instead of the vehicle. The rest is the same as that of the application processing unit 4a.

The sensor information includes, for example, speed information, traveling direction information, vibration information, noise information, radio wave information, and the like. The calculation information calculated by the application from the sensor information is, for example, position information on a road calculated by an application of a navigation system, operating information for enabling determination on whether it is of a vehicle, and the like. Of these, the speed information, the traveling direction information, the position information, the operating information, and the like are examples of movement information of the vehicle. The information on the execution of the application related to the vehicle is, for example, information indicating that the application of the navigation system is being executed. The sensor information transmitted from the sensor 9 or the application processing unit 4b, the calculation information calculated by the application of the application processing unit 4b from the sensor information, and the information on the execution of the application related to the vehicle are examples of second acquisition information that is the information related to the vehicle. The second acquisition information is an example of information related to a specific purpose. The environment in which the portable terminal device 1b is in the vehicle is an example of an operating environment in which direct communication is permitted.

The determination unit 5b determines whether or not the operating environment of the portable terminal device 1b is an operating environment permitting the direct communication on the basis of at least one of the sensor information transmitted from the sensor 9 or the application processing unit 4b, the calculation information calculated by the application of the application processing unit 4b from the sensor information, and the information on the execution of the application related to the vehicle.

Specifically, the determination unit 5b acquires at least one of the sensor information transmitted from the sensor 9, the sensor information transmitted from the application processing unit 4b, and the calculation information transmitted from the application processing unit 4b, and determines that the portable terminal device 1b is in the vehicle when determining that the acquired information is the information related to the vehicle. Or in a case where the determination unit 5b acquires the information on the execution of the application related to the vehicle that is transmitted from the application processing unit 4b, it determines that the vehicle is to be operated as a matter of course because the application related to the vehicle is executed, and determines that the portable terminal device 1b is in the vehicle.

The determination unit 5b is also connected to the sensor 9. The rest is the same as the determination unit 5a.

Next, a hardware configuration of the portable terminal device 1b according to Embodiment 2 will be described.

FIG. 5 is a hardware configuration diagram of the portable terminal device 1b according to Embodiment 2 of the present disclosure. The configuration of the portable terminal device 1b according to Embodiment 2 of the present disclosure will be described referring to FIG. 5.

In Embodiment 2, a sensor 14 is added as a component to the hardware configuration diagram in FIG. 2 of Embodiment 1. Note that the hardware configuration of the application processing unit 4b is the same as that of the application processing unit 4a, and the hardware configuration of the determination unit 5b is the same as that of the determination unit 5a. Instead of storing the vehicle information, the control information, and the like, the memory 12 stores the sensor information, the calculation information calculated by the application from the sensor information, the information on the execution of the application related to the vehicle, and the like.

The sensor 14 detects various types of sensor information. The sensor 14 is, for example, an acceleration sensor, a vibration sensor, or a sensor that detects a radio wave in the LF band or the UHF band for the communication with the smart key of the vehicle. The sensor 9 is implemented by the senor 14.

Next, operation of the portable terminal device 1b will be described.

The flowchart showing the operation of the determination unit 5b according to Embodiment 2 of the present disclosure is the same as FIG. 3 of Embodiment 1. However, the processing is performed by the application processing unit 4b instead of the application processing unit 4a and the determination unit 5b instead of the determination unit 5a. Further, since Embodiment 2 differs from Embodiment 1 only in the manner to determine in Step S102 whether or not the portable terminal device 1b is in the vehicle, the difference will be described below.

In Step S102, the determination unit 5b determines whether or not the portable terminal device 1b is in the vehicle. That is, similar to Embodiment 1, in a case where the determination unit 5b determines that the portable terminal device 1b is in the vehicle, the result is Yes in Step S102, and the processing proceeds to Step S104. When the determination unit 5b determines that the portable terminal device 1b is not in the vehicle, the determination result in Step S102 is No, and the processing proceeds to Step S103.

Specifically, in a case where the sensor 9 is the acceleration sensor, the determination unit 5b acquires speed information or traveling direction information from the sensor 9 or the application processing unit 4b. When the determination unit 5b determines that the acquired speed information or the acquired traveling direction information indicates movement of the vehicle, the determination unit determines that the portable terminal device 1b is in the vehicle, and thus the determination result in Step S102 is Yes, and the processing proceeds to Step S104. When the speed information or the traveling direction information cannot be acquired, or when it is not determined that the acquired speed information or the acquired traveling direction information indicates the movement of the vehicle, the determination unit 5b determines that the portable terminal device 1b is not in the vehicle, and thus the result in Step S102 is No, and the processing proceeds to Step S103. Note that the speed information and the traveling direction information are examples of the sensor information.

Or in a case where the sensor 9 is the vibration sensor, the determination unit 5b acquires noise information or vibration information from the sensor 9 or the application processing unit 4b. The determination unit 5b determines that the portable terminal device 1b is in the vehicle when determining that the acquired noise information or the acquired vibration information indicates a vehicle-specific noise or vibration, and thus the determination result in Step S102 is Yes, and the processing proceeds to Step S104. When the noise information or the vibration information cannot be acquired, or when it is not determined that the acquired noise information or the acquired vibration information indicates vehicle-specific noise or vibration, the determination unit 5b determines that the portable terminal device 1b is not in the vehicle, and thus the result is No in Step S102, and the processing proceeds to Step S103.

Or in a case where the sensor 9 is a sensor that detects a radio wave in the LF band or the UHF band for the communication with the smart key of the vehicle, the determination unit 5b acquires radio wave information from the sensor 9 or the application processing unit 4b. When determining that the acquired radio wave information indicates a radio wave in the LF band or the UHF band for the communication with the smart key of the vehicle, the determination unit 5b determines that the portable terminal device 1b is in the vehicle, the determination result in Step S102 is Yes, and the processing proceeds to Step S104. When the radio wave information is not acquired, or when it is not determined that the acquired radio wave information indicates the radio wave of the LF band or the UHF band for the communication with the smart key of the vehicle, the determination unit 5b determines that the portable terminal device 1b is not in the vehicle, the determination result in Step S102 is No, and the processing proceeds to Step S103. Note that the radio wave information is an example of the sensor information, and the radio wave in the LF band or the UHF band for the communication with the smart key of the vehicle is an example of a specific radio wave.

Or in a case where the application of the navigation system is executed by the application processing unit 4b, the determination unit 5b acquires the position information, the speed information, or the traveling direction information from the application of the navigation system in the application processing unit 4b. When determining that the acquired position information, the acquired speed information, or the acquired traveling direction information indicates a position on a road, the movement of the vehicle, or both of them, the determination unit 5b determines that the portable terminal device 1b is in the vehicle, and the determination result in Step S102 is Yes, and the processing proceeds to Step S104. When the position information, the speed information, or the traveling direction information cannot be acquired, or when it is not determined that the acquired position information, the acquired speed information, or the acquired travelling direction information indicates the position on the road, the movement of the vehicle, or both of them, the determination unit 5b determines that the portable terminal device 1b is not in the vehicle, and the determination result in Step S102 is No, and the processing proceeds to Step S103. Note that the position information, the speed information, and the traveling direction information acquired from the application of the navigation system are examples of the calculation information transmitted from the application processing unit 4b.

Or in a case where the application of the navigation system is being executed by the application in the application processing unit 4b, the determination unit 5b acquires information on the execution of the application related to the vehicle from the application processing unit 4b. When the determination unit 5b acquires the information on the execution of the application related to the vehicle that is transmitted from the application processing unit 4b, it determines that the vehicle is to be operated as a matter of course because the application related to the vehicle is executed, and determines that the portable terminal device 1b is in the vehicle. The determination result in Step S102 is Yes, and the processing proceeds to Step S104. When the determination unit 5b cannot acquire information on the execution of the application related to the vehicle, it determines that the portable terminal device 1b is not in the vehicle. The determination result in Step S102 is No, and the processing proceeds to Step S103. Note that the application of the navigation system is an example of the application related to the vehicle.

As described above, in the portable terminal device 1b according to Embodiment 2, the determination unit 5b determines whether the portable terminal device 1b is in the vehicle on the basis of at least one of the sensor information transmitted from the sensor 9 or the application processing unit 4b, the calculation information calculated by an application of the application processing unit 4b from the sensor information, and the information on the execution of the application related to the vehicle, and in the case where the device is not in the vehicle, since the control unit 3 restricts the direct communication, the direct communication can be controlled in consideration of the operating environment of the portable terminal device 1b.

Further, also in Embodiment 2, the portable terminal device 1b can suppress interference by restricting the direct communication of a purpose different from the intended purpose.

Also, in Embodiment 2, the portable terminal device 1b enables the direct communication of the V2X using the communication terminal device other than the communication device installed in the vehicle, thereby enabling the use of the communication in a retrofitting manner to the vehicle.

Note that, in Embodiment 2, an example in which the determination unit 5b is provided outside the control unit 3 is described. However, the determination unit 5b may be an internal function of the control unit 3.

In Embodiment 2, the determination unit 5b includes only one sensor 9, but the number of sensors 9 may be one or more. That is, a plurality of sensors 9 may be provided.

In Embodiment 2, although the determination is made by the determination unit 5b on the basis of one piece of information, the determination may be made on the basis of a plurality of pieces of information in combination.

In Embodiment 2, the sensor 9 is connected to the application processing unit 4b or the determination unit 5b but may be connected to both. At least one of the application processing unit 4b and the determination unit 5b is connected to the sensor 9 so as to be able to obtain the sensor information.

Although in Embodiment 2, the determination unit 5b determines whether or not the portable terminal device 1b is in the vehicle on the basis of the information only in the portable terminal device 1b, in the case in combination with Embodiment 1, when the application processing unit 4b acquires the vehicle information or the control information from the vehicle, it may determine that the portable terminal device 1b is in the vehicle if the information in the portable terminal device 1b matches the vehicle information or the control information acquired from the vehicle. Specifically, in a case where the vehicle and the application processing unit 4b are communicating with each other and the sensor 9 is the acceleration sensor, the determination unit 5b acquires the speed information or the traveling direction information acquired by the sensor 9 from the sensor 9 or the application processing unit 4b. The determination unit 5b acquires the speed information or the traveling direction information, which is the vehicle information acquired from the vehicle, from the application processing unit 4b via the control unit 3. When the speed information or the traveling direction information acquired by the sensor 9 matches the speed information or the traveling direction information acquired from the vehicle, the determination unit 5b determines that the portable terminal device 1b is in the vehicle. In this way, by determining that the portable terminal device is in the vehicle when the vehicle information and matches the sensor information, the accuracy of determining whether the portable terminal device 1b is in the vehicle is improved. The information for the determination by the determination unit 5b is not limited to the vehicle information and the sensor information, and may be the control information, the calculation information transmitted from the application processing unit 4b, the information on the execution of the application related to the vehicle, or the like.

In Embodiment 2, the determination unit 5b is provided in the portable terminal device 1b. However, a server in a base station for the portable terminal device or in a cloud or the like may include the determination unit 5b. Specifically, the above case can be adopted in a case where the communication between the portable terminal device 1b and the vehicle is not established yet, the portable terminal device 1b and the server are performing communication via the base station, and the vehicle and the server are performing communication of V2N or the like. The server includes a wireless communication unit for communicating with the portable terminal device 1b and the vehicle, and a determination unit 5b. The portable terminal device 1b transmits to the server, portable terminal device sensor information being information of the portable terminal device 1b such as the position information or the speed information acquired from the sensor 9. Similarly, the vehicle also transmits to the server, vehicle sensor information being the sensor information of the vehicle such as the position information or the speed information. The server determines whether or not the portable terminal device sensor information received from the portable terminal device 1b and the vehicle sensor information received from the vehicle match in the determination unit 5b. In the server, when the portable terminal device sensor information and the sensor information of the vehicle match with each other, the determination unit 5b determines that the portable terminal device 1b is in the vehicle, and the wireless communication unit transmits to the portable terminal device 1b, a notification of a permission to a transmission request or a determination result on whether or not the direct communication is permitted. The portable terminal device 1b performs the direct communication on the basis of the determination result received from the server.

### Embodiment 3

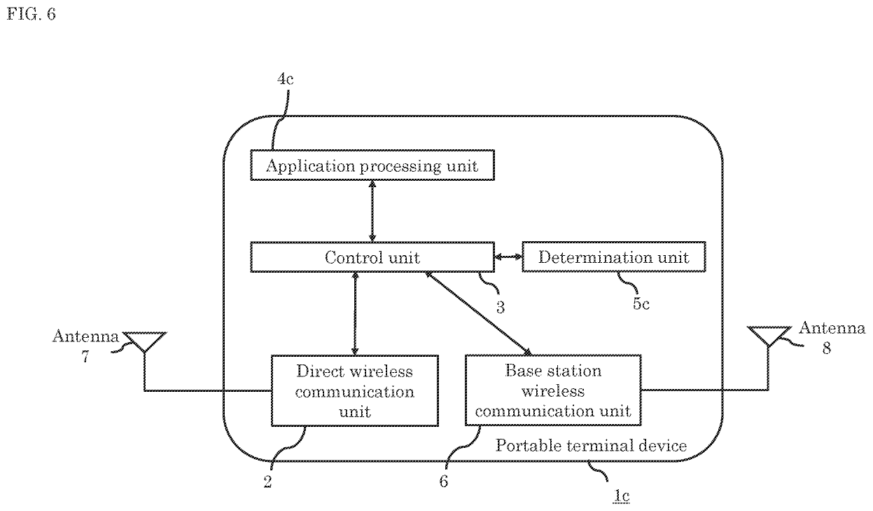

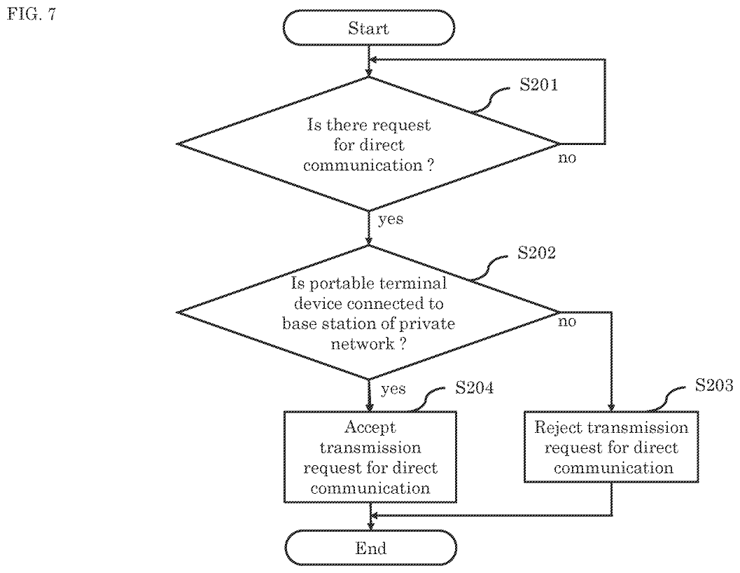

In Embodiments 1 and 2, a case is described in which the communication function for the direct communication installed in a smartphone being a portable terminal device is used for the direct communication of V2X. In Embodiment 3, as illustrated in FIGS. 6 to 7, a case will be described in which a communication function of the direct communication installed in a tablet terminal being the portable terminal device is used for the direct communication between portable terminal devices in a private network of a factory or the like, for example. Note that in Embodiment 3, the direct communication is performed between portable terminal devices, but the devices are not limited to the portable terminal devices, and another side performing the direct communication may be a communication device to perform the direct communication.

As a case where the direct communication in the private network is performed, for example, a case where communication for factory work is performed is considered. When communication for the purpose of the factory work is performed, a portable terminal device is typically connected to the base station for the private network, and the communication can be performed between the portable terminal device and the base station for the private network. Therefore, when the portable terminal devices are not connected to the base station for the private network, since the communication between the portable terminal devices is not the communication for the purpose of the factory work, the portable terminal devices need to restrict the direct communication. That is, when the portable terminal device having the communication function of the direct communication is brought out of the range of the private network, it is necessary to restrict the portable terminal device from performing the direct communication using a dedicated frequency of the private network.

In Embodiment 3 of the present disclosure, the portable terminal device has a function to determine whether the device exists within the private network, and if it is determined that the device does not exist within the private network, the portable terminal device restricts the direct communication. Contrary to the above, when the portable terminal device determines that the device exists within the range of the private network from control information received from the base station for the private network by an application of the private network, there is a high possibility that an application related to the factory work in the private network is executed in other applications, and thus the portable terminal device permits the direct communication in the communication of the other applications. The portable terminal device restricts the direct communication of the private network to the communication within the range of the private network, and thus it is possible to suppress the communication using the direct communication for another purpose. In the way described above, the portable terminal device can restrict the direct communication that is not for the intended purpose and suppress interference. The rest is the same as that in Embodiments 1 and 2. In the following description, the same reference numerals are given to the configurations and the operation already described, and repetitive descriptions will be omitted.

FIG. 6 is a functional block diagram of the portable terminal device 1c according to Embodiment 3 of the present disclosure.

In Embodiment 3, an application processing unit 4c and a determination unit 5c are added as components of the functional block diagram instead of the application processing unit 4a and the determination unit 5a in FIG. 1 of Embodiment 1.

In Embodiment 3, the antenna 8 communicates with the base station in the private network. Further, in Embodiment 3, a frequency band permitted for a specific purpose is set for the dedicated frequency band of the private network, and the direct wireless communication unit 2 performs the direct communication with another portable terminal device in the dedicated frequency band of the private network.

In the case of the private network as in Embodiment 3, unlike Embodiments 1 and 2, frequency for the direct communication is less likely to be allocated. It is assumed that the dedicated frequency band is allocated for the private network, and the frequency of the communication via the base station for the private network and the frequency of the direct communication are the same in use. Although the way described above is assumed in Embodiment 3, the frequency band permitted for the specific purpose may be a frequency band allocated for the direct communication of the private network, as in Embodiments 1 and 2.

In Embodiment 3, when the determination unit 5c determines that an operating environment of the device is not connected to the private network, the direct communication by the direct wireless communication unit 2 is restricted.

The application processing unit 4c executes the application of the private network for performing the communication via the base station for the private network. Note that the number of applications of the private network may be one or more; namely, it may be single or multiple. The application processing unit 4c acquires the control information received from the base station for the private network from the base station wireless communication unit 6 through the control unit 3 and uses it for an application. Here, the control information received from the base station for the private network is an example of information related to the specific purpose.

The application processing unit 4c transmits the control information from the base station for the private network to the determination unit 5c through the control unit 3. The application processing unit 4c is connected only to the control unit 3. The rest is the same as the application processing unit 4a.

The determination unit 5c determines whether or not the operating environment of the portable terminal device 1c is an operating environment in which the direct communication is permitted, on the basis of the control information received from the base station for the private network.

Specifically, when the control information is acquired from the base station for the private network, the determination unit 5c determines that the portable terminal device 1c is connected to the base station for the private network, and determines that the portable terminal device 1c exists within the range of the private network. When determining that the portable terminal device 1c exists within the range of the private network, the determination unit 5c permits the control unit 3 to transmit information that is to be transmitted from the application processing unit 4c to another portable terminal device, by the direct communication. When the control information cannot be acquired from the base station for the private network, the determination unit 5c determines that the portable terminal device 1c is not connected to the base station for the private network, and determines that the portable terminal device 1c exists outside the range of the private network. When the determination unit 5c determines that the portable terminal device 1c exists outside the range of the private network, the determination unit rejects, to the control unit 3, transmission of the information being transmitted by direct communication from the application processing unit 4c to the another portable terminal device. Here, an environment in which the portable terminal device 1c is connected to the base station for the private network is an example of the operating environment in which the direct communication is permitted. The rest is the same as the determination unit 5a

The hardware configuration diagram of the portable terminal device 1c according to Embodiment 3 of the present disclosure is the same as FIG. 2 of Embodiment 1. The hardware configuration of the application processing unit 4c is the same as that of the application processing unit 4a, and the hardware configuration of the determination unit 5c is the same as that of the determination unit 5a. The memory 12 stores the control information for the communication between the portable terminal device 1a and the base station for the private network, instead of storing the vehicle information and the control information for the communication between the portable terminal device 1c and the vehicle.

Next, operation of the portable terminal device 1c will be described.

FIG. 7 is a flowchart showing the operation of the determination unit 5c according to Embodiment 3 of the present disclosure. The operation of the determination unit 5c will be described referring to FIG. 7.

Step S201 is the same as Step S101 of Embodiment 1. Note that the determination unit 5c performs processing instead of the determination unit 5a, and the application processing unit 4c performs processing instead of the application processing unit 4a.

In Step S202, the determination unit 5c determines whether or not the portable terminal device 1c is connected to the base station for the private network. Specifically, the determination unit 5c determines whether or not the application processing unit 4c acquires the control information from the base station for the private network. For example, when the application of the private network is executed in the application processing unit 4c and the application processing unit 4c acquires the control information from the base station for the private network, the determination unit 5c determines that the portable terminal device 1c is connected to the base station for the private network, and thus the result in Step S202 is Yes, and the processing proceeds to Step S204. When the control information cannot be acquired from the base station for the private network, the determination unit 5c determines that the portable terminal device 1c is not connected to the base station for the private network, and thus the result in Step S202 is No, and the processing proceeds to Step S203.

In Step S203, the determination unit 5c notifies the control unit 3 that the transmission request is rejected, and the processing ends. At this time, the control unit 3 restricts the transmission of the information from an application to another portable terminal device by the direct communication of the private network by the direct wireless communication unit 2 on the basis of the determination result of the determination unit 5c.

In Step S204, the determination unit 5c notifies the control unit 3 that the transmission request is permitted, and the processing ends. Note that, at this time, the control unit 3 controls to transmit information from the application to another portable terminal device by the direct communication of the private network by the direct wireless communication unit 2 on the basis of the determination result of the determination unit 5c.

After the execution of Step S203 or Step S204, the processing returns to Step S201, and the processing described above is repeated until the power supply is turned off or until there is a trigger for termination of the processing; namely, a termination operation is performed for example, and thereby the direct communication for a purpose different from the intended purpose can be restricted. Although the processing described above is repeated, the processing may be performed only once without being repeated.

As described above, in the portable terminal device 1c of Embodiment 3, when the determination unit 5c determines whether or not the portable terminal device 1c is connected to the base station for the private network on the basis of whether or not the control information is acquired, and determines that the portable terminal device 1c is not connected to the base station for the private network, the control unit 3 restricts the direct communication. Therefore, it is possible to control the direct communication in consideration of the operating environment of the portable terminal device 1c.

Further, also in Embodiment 3, the portable terminal device 1c can suppress interference by restricting the direct communication of a purpose different from the intended purpose.

Note that, in Embodiment 3, an example in which the determination unit 5c is provided outside the control unit 3 is described. However, the determination unit 5c may be an internal function of the control unit 3.

Note that the portable terminal device, the communication control system, the communication control method, and the communication control program in Embodiments described above are merely examples and can be configured in combination with other devices appropriately and are not limited to a single configuration of an embodiment.

### DESCRIPTION OF REFERENCE NUMERALS AND SIGNS

1a, 1b, 1c portable terminal device, 2 direct wireless communication unit, 3 control unit, 4a, 4b, 4c application processing unit, 5a, 5b, 5c determination unit, 6 base station wireless communication unit, 7 antenna, 8 antenna, 9 sensor, 10 bus, 11 processor, 12 memory, 13 communication I/F, 14 sensor

1. A portable terminal device comprising:
direct wireless communication circuitry to perform direct communication permitted for a specific purpose;
determining circuitry to determine whether or not an operating environment of the device is an operating environment to permit the direct communication; and
controlling circuitry to control the direct communication by the direct wireless communication circuitry on the basis of a determination result of the determining circuitry, wherein
the determining circuitry determines the operating environment of the device not to be the operating environment to permit the direct communication in a case where information acquired inside or outside the device is not information on the specific purpose;
the controlling circuitry restricts the direct communication by the direct wireless communication circuitry in a case where the determining circuitry determines the operating environment of the device not to be the operating environment to permit the direct communication;
the direct communication is a communication of Vehicle to Everything (V2X);
the operating environment to permit the direct communication is an environment in which the device is in a vehicle;
the determining circuitry determines the operating environment of the device to be an environment in which the device is in a vehicle in a case where information acquired inside or outside the device is first acquisition information being information acquired from the vehicle in which the device exists;
the first acquisition information is control information for communication between the device and the vehicle; and
the determining circuitry determines the operating environment of the device to be an environment in which the device is in a vehicle when determining that the vehicle is operated on the basis of vehicle information being information related to the vehicle acquired from the vehicle in addition to a case in which information acquired inside or outside the device is the control information.

2. A portable terminal device comprising:
direct wireless communication circuitry to perform direct communication permitted for a specific purpose;
determining circuitry to determine whether or not an operating environment of the device is an operating environment to permit the direct communication; and
controlling circuitry to control the direct communication by the direct wireless communication circuitry on the basis of a determination result of the determining circuitry, wherein
the determining circuitry determines the operating environment of the device not to be the operating environment to permit the direct communication in a case where information acquired inside or outside the device is not information on the specific purpose;
the controlling circuitry restricts the direct communication by the direct wireless communication circuitry in a case where the determining circuitry determines the operating environment of the device not to be the operating environment to permit the direct communication;
the direct communication is a communication within a private network,
the operating environment that permits the direct communication is an environment in which the device is connected to a base station for the private network; and
the determining circuitry determines the operating environment of the device to be an environment in which the device is connected to the base station for the private network in a case where the information acquired inside or outside the device is control information received from the base station for the private network.

3. A communication control system comprising:
a portable terminal device capable of direct communication; and
a server to determine whether the portable terminal device is permitted to perform the direct communication on the basis of information received from the portable terminal device and a vehicle, wherein
the portable terminal device includes:
direct wireless communication circuitry to perform the direct communication permitted for a specific purpose;
base station wireless communication circuitry to transmit to the server, portable terminal device sensor information being information on the portable terminal device acquired from a sensor of the portable terminal device and to receive a determination result from the server regarding whether or not the direct communication is permitted; and
controlling circuitry to control the direct communication by the direct wireless communication circuitry on the basis of the determination result, and
the server includes:
wireless communication circuitry to receive from the vehicle, vehicle sensor information being sensor information on the vehicle, to receive the portable terminal device sensor information from the portable terminal device, and to transmit a determination result to the portable terminal device regarding whether or not the direct communication is permitted; and
determining circuitry to determine whether or not an operating environment of the portable terminal device is an operating environment to permit the direct communication on the basis of the vehicle sensor information and the portable terminal device sensor information, wherein
the determining circuitry determines the operating environment of the portable terminal device not to be the operating environment to permit the direct communication in a case where information acquired inside or outside the portable terminal device is not information on the specific purpose;
the controlling circuitry restricts the direct communication by the direct wireless communication circuitry in a case where the determining circuitry determines the operating environment of the portable terminal device not to be the operating environment to permit the direct communication;
the direct communication is a communication of Vehicle to Everything (V2X);
the operating environment to permit the direct communication is an environment in which the portable terminal device is in a vehicle;
the determining circuitry determines the operating environment of the portable terminal device to be an environment in which the portable terminal device is in a vehicle in a case where the information acquired inside or outside the portable terminal device is first acquisition information being information acquired from the vehicle in which the portable terminal device exists;
the first acquisition information is control information for communication between the device and the vehicle; and
the determining circuitry determines the operating environment of the portable terminal device to be an environment in which the portable terminal device is in a vehicle when determining that the vehicle is operated on the basis of vehicle information being information related to the vehicle acquired from the vehicle in addition to a case in which the information acquired inside or outside the portable terminal device is the control information.

4. A communication control system comprising:
a portable terminal device capable of direct communication; and
a server to determine whether the portable terminal device is permitted to perform the direct communication on the basis of information received from the portable terminal device and a vehicle, wherein
the portable terminal device includes:
direct wireless communication circuitry to perform the direct communication permitted for a specific purpose;
base station wireless communication circuitry to transmit to the server, portable terminal device sensor information being information on the portable terminal device acquired from a sensor of the portable terminal device and to receive a determination result from the server regarding whether or not the direct communication is permitted; and
controlling circuitry to control the direct communication by the direct wireless communication circuitry on the basis of the determination result, and
the server includes:
wireless communication circuitry to receive from the vehicle, vehicle sensor information being sensor information on the vehicle, to receive the portable terminal device sensor information from the portable terminal device, and to transmit a determination result to the portable terminal device regarding whether or not the direct communication is permitted; and
determining circuitry to determine whether or not an operating environment of the portable terminal device is an operating environment to permit the direct communication on the basis of the vehicle sensor information and the portable terminal device sensor information, wherein
the determining circuitry determines the operating environment of the portable terminal device not to be the operating environment to permit the direct communication in a case where information acquired inside or outside the portable terminal device is not information on the specific purpose;
the controlling circuitry restricts the direct communication by the direct wireless communication circuitry in a case where the determining circuitry determines the operating environment of the portable terminal device not to be the operating environment to permit the direct communication;
the direct communication is a communication within a private network;
the operating environment that permits the direct communication is an environment in which the portable terminal device is connected to a base station for the private network; and
the determining circuitry determines the operating environment of the portable terminal device to be an environment in which the device is connected to the base station for the private network in a case where the information acquired inside or outside the portable terminal device is control information received from the base station for the private network.

5. A communication control method comprising:
a first step of performing direct communication permitted for a specific purpose;
a second step of determining whether or not an operating environment of a portable terminal device is an operating environment to permit the direct communication; and
a third step of controlling the direct communication by the portable terminal device on the basis of a determination result of the second step, wherein,
in the second step, the operating environment of the portable terminal device is determined not to be the operating environment to permit the direct communication in a case where information acquired inside or outside the portable terminal device is not information on the specific purpose;
in the third step, the direct communication is restricted in a case where the operating environment of the portable terminal device is determined not to be the operating environment to permit the direct communication in the second step;
the direct communication is a communication of Vehicle to Everything (V2X);
the operating environment to permit the direct communication is an environment in which the portable terminal device is in a vehicle;
in the second step, the operating environment of the portable terminal device is determined to be an environment in which the portable terminal device is in a vehicle in a case where the information acquired inside or outside the portable terminal device is first acquisition information being information acquired from the vehicle in which the portable terminal device exists;
the first acquisition information is control information for communication between the portable terminal device and the vehicle; and
in the second step, the operating environment of the portable terminal device is determined to be an environment in which the portable terminal device is in a vehicle when the vehicle is determined to be operated on the basis of vehicle information being information related to the vehicle acquired from the vehicle in addition to a case in which the information acquired inside or outside the portable terminal device is the control information.

6. A communication control method comprising:
a first step of performing direct communication permitted for a specific purpose;
a second step of determining whether or not an operating environment of a portable terminal device is an operating environment to permit the direct communication; and
a third step of controlling the direct communication by the portable terminal device on the basis of a determination result of the second step, wherein,
in the second step, the operating environment of the portable terminal device is determined not to be the operating environment to permit the direct communication in a case where information acquired inside or outside the portable terminal device is not information on the specific purpose;
in the third step, the direct communication is restricted in a case where the operating environment of the portable terminal device is determined not to be the operating environment to permit the direct communication in the second step;
the direct communication is a communication within a private network,
the operating environment that permits the direct communication is an environment in which the device is connected to a base station for the private network; and
in the second step, the operating environment of the portable terminal device is determined to be an environment in which the portable terminal device is connected to the base station for the private network in a case where the information acquired inside or outside the portable terminal device is control information received from the base station for the private network.
